(19) United States
(12) Patent Application Publication
(10) Pub. No.: US 2025/0027668 A1
(43) Pub. Date: Jan. 23, 2025

(54) METHODS AND SYSTEMS FOR EVALUATING ENERGY CONSERVATION AND GUEST SATISFACTION IN HOTELS

(71) Applicant: Honeywell International Inc., Charlotte, NC (US)

(72) Inventors: Bhavesh Gupta, Bangalore (IN); Gunjan Chanduka, Bangalore (IN); Magesh Lingan, Bangalore (IN); Zhongshengyun Gao, Shanghai (CN); Gregory Howard, Amston, CT (US); Raushan Kumar Ravi, Burnaby (CA); Prabhat Ranjan, Bangalore (IN); Grant Patterson, Charlotte, NC (US)

(21) Appl. No.: 18/908,274

(22) Filed: Oct. 7, 2024

Related U.S. Application Data
(63) Continuation of application No. 17/866,421, filed on Jul. 15, 2022, now Pat. No. 12,135,137.
Application No. 17/866,421 is a continuation of application No. 16/985,069, filed on Aug. 4, 2020, now Pat. No. 11,402,113.

(51) Int. Cl. F24F 11/46; F24F 11/49; F24F 120/10; F24F 140/60; G06F 1/3209; G06F 1/3231

(52) U.S. Cl. CPC F24F 11/46; G06F 1/3209; G06F 1/3231; F24F 11/49; F24F 2120/10; F24F 2140/60

(57) ABSTRACT

A method for determining an energy score for a guest room of a hotel having a plurality of guest rooms includes identifying two or more energy saving conditions associated with the guest room under which there is an opportunity to save energy when controlling the guest room without sacrificing guest comfort. The guest room is controlled in a designated energy savings mode when one or more of the energy savings room conditions are detected, and controlling the guest room in a guest comfort mode when none of the energy savings room conditions are detected. An energy score for the guest room is determined based at least in part on a measure of reliability of detecting the two or more energy savings conditions of the guest room, and thus the ability to take advantage of the opportunities to save energy when controlling the guest room.

This is a continuation of co-pending U.S. patent application Ser. No. 17/866,421, filed Jul. 15, 2022, and entitled “METHODS AND SYSTEMS FOR EVALUATING ENERGY CONSERVATION AND GUEST SATISFACTION IN HOTELS”, which is a continuation of co-pending U.S. patent application Ser. No. 16/985,069, filed Aug. 4, 2020, and entitled “METHODS AND SYSTEMS FOR EVALUATING ENERGY CONSERVATION AND GUEST SATISFACTION IN HOTELS”, now U.S. Pat. No. 11,402,113, both of which are incorporated herein by reference.

### TECHNICAL FIELD

The present disclosure relates generally to hotels. More particularly, the present disclosure relates to evaluating energy conservation and/or guest satisfaction in hotels.

### BACKGROUND

Hotels can include a large number of hotel rooms that can be rented out by guests. When individual hotel rooms are not rented out, there are opportunities to achieve energy savings, particularly in heating, ventilating and air conditioning (HVAC) systems that provide conditioned air for the individual hotel rooms. Energy savings may also be achieved in lighting systems, for example. When individual hotel rooms are rented, but are currently not occupied, there are also opportunities for energy savings. However, a need to provide a satisfying guest experience can limit possible energy savings because, for example, the possibility that a guest may soon occupy the individual hotel room means that the temperature set point in the room may not be allowed to change as much from a comfort temperature set point. What would be desirable is an improved way to manage opportunities for achieving energy savings while also maintaining a satisfactory guest experience.

### SUMMARY

The present disclosure relates generally to evaluating energy conservation and/or guest satisfaction in hotels. In one example, a method for determining an energy score for a guest room of a hotel having a plurality of guest rooms includes identifying two or more energy saving conditions associated with the guest room under which there is an opportunity to save energy when controlling the guest room without sacrificing guest comfort. The guest room is controlled in a designated energy savings mode when one or more of the energy savings room conditions are detected, and controlling the guest room in a guest comfort mode when none of the energy savings room conditions are detected. An energy score for the guest room is determined based at least in part on a measure of reliability of detecting the two or more energy savings conditions of the guest room, and thus the ability to take advantage of the opportunities to save energy when controlling the guest room.

In another example, a system for determining an energy score for a guest room of a hotel having a plurality of guest rooms includes a hotel network to which each of the plurality of guest rooms are operably coupled to. A server is remote from the plurality of guest rooms and is configured to receive via one or more networks including the hotel network one or more room connectivity parameters that provide an indication of network connectivity to a guest room. The server is configured to receive via the one or more networks a PMS connectivity parameter that provides an indication of network connectivity to a Property Management System (PMS) of the hotel. The server is configured to determine an energy score based at least in part on the one or more room connectivity parameters and the PMS connectivity parameter and to display on a display the energy score.

In another example, a method of determining a guest comfort score for a guest staying in a guest room of a plurality of guest rooms of a hotel facility. Each of the plurality of guest rooms including a connected thermostat. A server is configured to receive an indication that the guest room is rented and occupied. The server also receives a plurality of parameters from one or more devices within the guest room for times when the guest room is rented and occupied, and is configured to determine two or more partial comfort scores based at least in part on one of more of the plurality of parameters. The server calculates a guest comfort score for the guest room by determining a weighted combination of two or more of the partial comfort scores for times when the guest room is determined to have been rented and occupied and displays on a display the guest comfort score calculated for the guest room.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative hotel management system;

FIG. 2 is a flow diagram showing an illustrative method that may be carried out using the illustrative hotel management system of FIG. 1;

FIG. 3 is a flow diagram showing an illustrative method that may be carried out using the illustrative hotel management system of FIG. 1;

FIG. 4 is a flow diagram showing an illustrative method that may be carried out using the illustrative hotel management system of FIG. 1;

FIG. 5 is a flow diagram showing an illustrative method that may be carried out using the illustrative hotel management system of FIG. 1;

FIG. 6A through 6F illustrate an energy-related dashboard; and

FIG. 7A through 7D illustrate a guest comfort-related dashboard.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic is described in connection with an embodiment, it is contemplated that the feature, structure, or characteristic may be applied to other embodiments whether or not explicitly described unless clearly stated to the contrary.

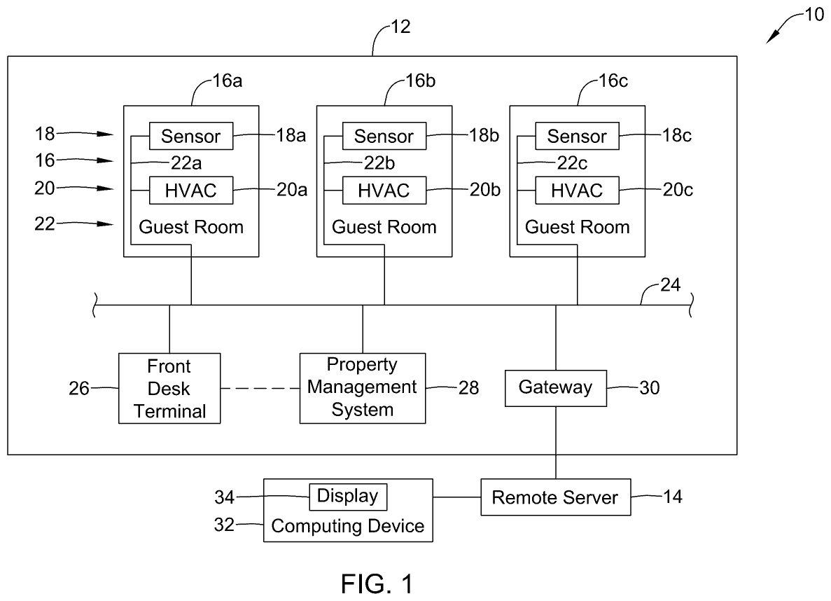

FIG. 1 is a schematic block diagram of an illustrative hotel management system 10. The illustrative hotel management system 10 is installed in a hotel 12 and includes a remote server 14 remote from the hotel 12. While the remote server 14 is shown as being exterior to the hotel 12, this is not required in all cases. It is contemplated that the remote server 14 could be disposed within the hotel 12, if desired. The remote server 14 may be a single computer, or the remote server 14 may represent a cloud-based server that includes one or more different computers. The hotel 12 includes a number of guest rooms 16 that are individually labeled as 16a, 16b, 16c. It will be appreciated that this is merely illustrative, as the hotel 12 will typically include a much greater number of guest rooms 16. Each guest room 16 includes one or more sensors 18, although only one sensor 18 is shown per guest room 16. The sensors 18 are individually labeled as 18a, 18b, 18c. The sensors 18 may, for example, be environmental sensors such as temperature sensors, humidity sensors, light sensors, and/or any other suitable sensor. In some cases, one or more of the sensors 18 may be disposed within a room thermostat within at least some of the guest rooms 16. Alternatively, or in addition, the sensors 18 may include occupancy sensors such as PIR sensors, mm Wave sensors, motion sensors and/or microphones, for example. Some of the sensors 18 may be part of a security system of the hotel 12.

Some of the sensors 18 may be configured to provide data points indicative of guest activities in the guest room. To help identify a sleep quality score of a guest, at least some of the sensors 18 may be configured to provide data points that include a measure related to a number of interactions with a thermostat in the corresponding guest room 16 that occur during a defined thermostat interaction detection time period at night. The data points may include a measure related to motion detected by a motion sensor in the corresponding guest room 16 that occur during a defined motion detection time period at night. The data points may include a measure related to changes in an ambient light level detected by a light sensor in the corresponding guest room 16 that occur during a defined ambient light level detection time period at night. In some cases, the data points provided by the sensors 18 may include a measure related to a noise detected by a noise detector in the corresponding guest room that occur during a defined noise detection time period at night. In some cases, the thermostat interaction detection time period, the motion detection time period, the ambient light level detection time period and the noise detection time period each include the time period from 2 AM to 3 AM, for example. In some instances, the data points include one or more sleep parameters that are provided by one or more sensors within a bed in the guest room 16. In this case, the sensor 18, or one of multiple sensors 18 within the guest room 16, may be embedded in the guest's bed.

Each of the guest rooms 16 of the hotel 12 includes a heating, ventilating and air conditioning (HVAC) system 20, individually labeled as 20a, 20b, 20c. The HVAC system 20 in each guest room 16 may be any of a variety of different types of HVAC systems, including split systems. In many cases, the HVAC system 20 in each guest room 16 may be configured to provide warm air, cool air and ambient temperature air circulation as needed, in order to maintain a particular temperature set point within the guest room 16. The particular temperature set point may, for example, include a predetermined temperature set point that is determined for all guest rooms 16 within the hotel 12, particularly for times at which a particular guest room 16 is not rented, or for times at which a particular guest room 16 is rented, but is not occupied. At times in which a particular guest room 16 is both rented and occupied, the temperature set point for that particular guest room 16 may ultimately be determined by the guest, interacting with a room thermostat, for example.

Each of the guest rooms 16 may include a room network 22, individually labeled as 22a, 22b, 22c. The room network 22 in each guest room 16 may be operably coupled with the sensor 18 and the HVAC system 20 within that guest room 16. The room network 22 in each guest room 16 may be a wired network, such as an Ethernet network, or the room network 22 in each guest room may be a wireless network. Each of the room networks 22 may be considered as being operably coupled with a hotel network 24. Accordingly, data from each guest room 16 can reach the hotel network 24, and thus can be passed on to other devices. Similarly, instructions or other commands from outside the individual guest rooms 16 may be passed to devices within each guest room 16, such as but not limited to the sensors 18 and the HVAC systems 20.

In some cases, the hotel network 24 is also operably coupled to devices that are exterior to the guest rooms 16. For example, the hotel 12 may include a front desk terminal 26. The front desk terminal 26 may, for example, be configured to allow hotel employees to check guests in and out of the hotel 12. While one front desk terminal 26 is shown, it will be appreciated that many hotels 12 may have more than one front desk terminal 26. In some hotels 12, for example, a guest may be able to check themselves out of their guest room 16 using the television in their room. In such cases, the television may be considered as functioning as a terminal, and may replace some of the functionality of the front desk terminal 26. Accordingly, the television in each guest room 16 may also be operably coupled to the hotel network 24.

The illustrative hotel 12 includes a Property Management System (PMS) 28. The PMS 28 may be considered as including software that tracks which guest rooms 16 are rented and which guest rooms 16 are not rented. The PMS 28 may track other parameters and features as well. For example, the PMS 28 may track movie and game rentals within each of the guest rooms 16, so that these rentals can be accounted for and correctly billed to the appropriate room renters. While the PMS 28 is shown as being operably coupled to the hotel network 24, in some cases the PMS 28 may also be coupled with the front desk terminal 26, as indicated in FIG. 1 via a dashed line between the PMS 28 and the front desk terminal 26.

A gateway 30 may provide a connection between the hotel network 24, and hence the various devices operably coupled to the hotel network 24, and the remote server 14. In some cases, the gateway 30 may be as simple as a modem/router that permits the hotel network 24, and the devices on the hotel network 24, to access wide area networks (WAN) such as but not limited to the Internet. The gateway 30 may be configured to allow software to be downloaded to the gateway 30 from the remote server 14. In some cases, the software downloaded to the gateway 30 may provide the gateway 30 with additional functionality. The software downloaded to the gateway 30 may, for example, assist the gateway 30 in communicating with the individual room networks 22 and/or the individual components such as the sensors 18 and/or the HVAC systems 20 within each of the guest rooms 16. The software downloaded to the gateway 30 may allow the gateway 30 to provide/pass commands to the individual components such as the sensors 18 and/or the HVAC systems 20 if desired.

The illustrative system 10 includes a computing device 32 that is operably coupled to the remote server 14. While shown outside of the hotel 12, in some cases the computing device 32 may instead be disposed within the hotel 12. The computing device 32 allows an individual to access information available on the hotel network 24. In the example shown, the computing device 32 includes a display 34 that may be used to display information. While not illustrated, it will be appreciated that the computing device 32 may also include data entry options such as a keyboard, mouse, trackball and the like. The computing device 32 may be a lap top computer, a desktop computer, a mobile phone, a tablet computer, and/or any other suitable computing device. In some cases, the remote server 14 and the computing device 32 may be one and the same.

In some instances, the remote server 14 may be configured to receive and/or compute one or more room connectivity parameters that provide an indication of network connectivity to one of the guest rooms 16. This may provide, for example, an indication of whether the room network 22 within a particular guest room 16 is operational or not. In some cases, the one or more room connectivity parameters may include a room uptime parameter that provides an indication of how long a particular guest room 16 has been online relative to a given period of time. The one or more room connectivity parameters may include a router uptime parameter that provides an indication of how long the hotel network 24 has been online relative to the given period of time.

The remote server 14 may be configured to receive and/or compute a PMS connectivity parameter that provides an indication of network connectivity to the Property Management System (PMS) 28 of the hotel 12. The PMS connectivity parameter may include a PMS uptime parameter that provides an indication of how long the PMS 28 has been online relative to the given period of time.

In some cases, the remote server 14 is configured to determine an energy score based at least in part on the one or more room connectivity parameters and the PMS connectivity parameter and to display the energy score on a display such as the display 34 of computing device 32. The energy score may be based at least in part on the one or more room connectivity parameters associated with each of the plurality of guest rooms 16. In some cases, the remote server 14 may be configured to display the aggregate energy score for all of the rooms in the hotel 12 in combination with an aggregate energy score for a comparison hotel. In some cases, the remote server 14 may be configured to display an energy score for each guest room 16 in combination with an aggregate energy score for the hotel 12, to show how the particular guest rooms 16 fare relative to the rest of the hotel 12.

In some cases, the system 10 may be configured to evaluate a hotel guest's satisfaction with the hotel 12. The remote server 14 may be configured to receive a data points from the sensors 18 via a connection to the hotel network 24. The remote server 14 may use the data points to calculate a guest satisfaction score for the guest room 16 and to display the guest satisfaction score. The guest satisfaction score may, for example, include a guest sleep quality score. In some cases, the remote server 14 only calculates the guest satisfaction score when the guest room 16 is determined to be occupied. The remote server 14 may be configured to display an aggregate guest satisfaction score in combination with a guest satisfaction score for each of one or more other guest rooms within the hotel.

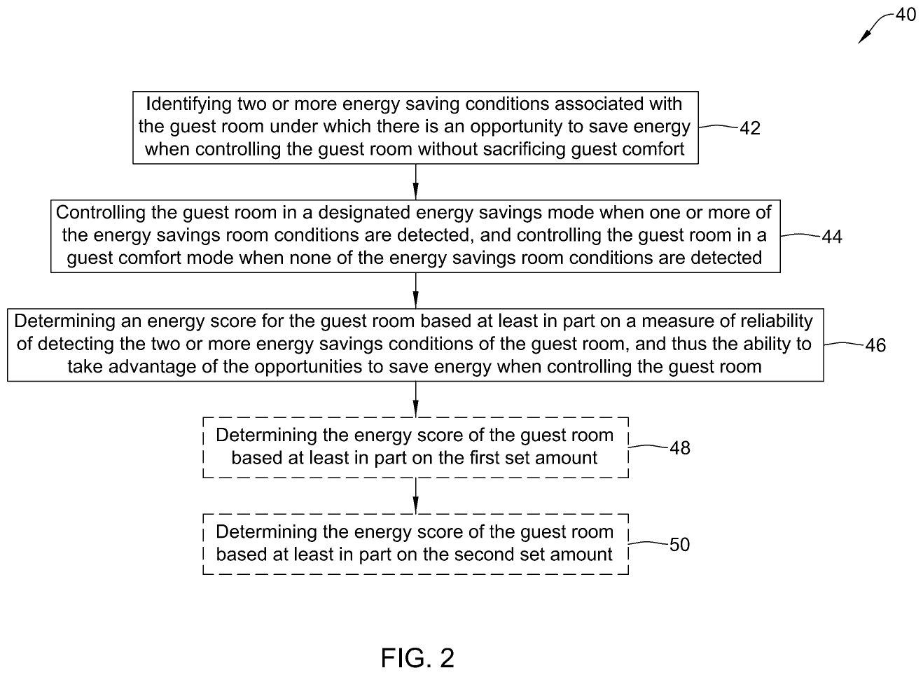

FIG. 2 is a flow diagram showing an illustrative method 40 for determining an energy score for a guest room (such as a guest room 16) of a hotel (such as the hotel 12). Two or more energy saving conditions associated with the guest room under which there is an opportunity to save energy when controlling the guest room without sacrificing guest comfort are identified, as indicated at block 42. In some cases, one of the two or more energy savings conditions includes a guest room rental status of un-rented. One of the two or more energy savings conditions may include a guest room occupancy status of rented but un-occupied. In some cases, a Property Management System (PMS) of the hotel identifies the guest room rental status, and wherein a PMS connectivity parameter representative of a reliability of a connection to the PMS determines at least in part the measure of reliability of detecting the two or more energy savings conditions of the guest room. When an occupancy sensor of the room has failed or is otherwise not providing reliable data, the measure of reliability of detecting the occupancy status of the room may be affected. These are just examples.

The guest room is controlled in a designated energy savings mode when one or more of the energy savings room conditions are detected, and is controlled in a guest comfort mode when none of the energy savings room conditions are detected, as indicated at block 44. An energy score for the guest room is determined based at least in part on a measure of reliability of detecting the two or more energy savings conditions of the guest room, and thus the ability to take advantage of the opportunities to save energy when controlling the guest room, as indicated at block 46.

In some cases, one or more sensors of the guest room may be used to identify the guest room occupancy status, and wherein a room connectivity parameter representative of a reliability of a connection to the guest room determines at least in part the measure of reliability of detecting the two or more energy savings conditions of the guest room. One or more sensors within the guest room may be used to identify the guest room occupancy status, and wherein an occupancy detection parameter representative of a reliability of occupancy detection in the guest room determines at least in part the measure of reliability of detecting the two or more energy savings conditions of the guest room.

In some cases, one of the two or more energy savings conditions includes a guest room rental status of un-rented and another of the two or more energy savings conditions comprises a guest room occupancy status of un-occupied. When a guest room rental status of rented is detected and a guest room occupied status of un-occupied is detected, a first designated energy savings mode is used that deviates from the guest comfort mode by a first set amount. The first set amount may be set by the hotel, and may be a pre-set offset from the guest comfort set point, a fixed temperature value, or any other value suitable for saving energy. In some cases, the first set amount may increase with time such that the guest room temperature is allowed to deviate more as the guest remains away for a longer period of time.

When a guest room rental status of un-rented is detected, a second designated energy savings mode is used that deviates from the guest comfort mode by a second set amount, wherein the second set amount is greater than the first set amount. In some cases, the energy score of the guest room may be based at least in part on the first set amount, as optionally indicated at block 48. The energy score of the guest room may be based at least in part on the second set amount, as optionally indicated at block 50.

The first set amount and the second set amount may be defined when the system 10 is originally configured, for example. In some cases, hotel management may be able to adjust the first set amount and the second set amount, in order to account for seasonal changes, local preferences and the like. As an example, the first set amount may indicate a temperature swing of plus/minus 2 degrees from a temperature set point. The second set amount may indicate a temperature swing of plus/minus 3 degrees, or even plus/minus 4 degrees from the temperature set point. These are just examples.

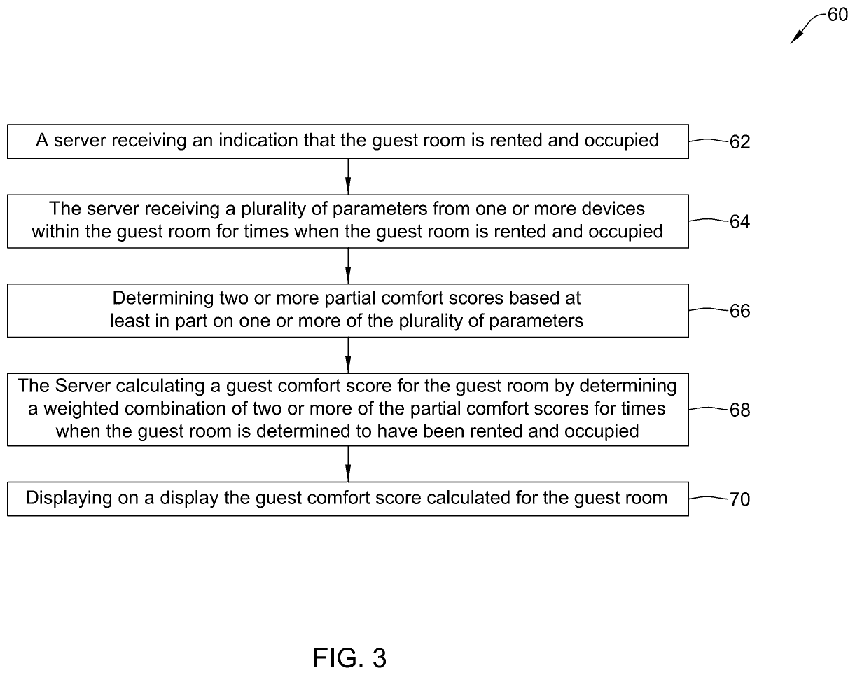

FIG. 3 is a flow diagram showing an illustrative method 60 of determining a guest comfort score for a guest who is staying in a guest room (such as the guest room 16) of a plurality of guest rooms of a hotel facility (such as the hotel 12), where each of the guest rooms include a connected thermostat. A server (such as the remote server 14) receives an indication that the guest room is rented and occupied, as indicated at block 62. The server receives a plurality of parameters from one or more devices within the guest room for times when the guest room is rented and occupied, as indicated at block 64. Two or more partial comfort scores that are based at least in part on one of more of the plurality of parameters are determined, as indicated at block 66. The server calculates a guest comfort score for the guest room by determining a weighted combination of two or more of the partial comfort scores for times when the guest room is determined to have been rented and occupied, as indicated at block 68. The server displays on a display the guest comfort score that was calculated for the guest room, as indicated at block 70.

In some instances, the two or more partial comfort scores may include a partial score that provides a measure of how often an HVAC system of the guest room was unable to achieve a guest selected setpoint within a predefined period of time. The two or more partial scores may include a partial score that provides a measure of how often a guest interacted with a thermostat of the guest room. In some cases, the two or more partial comfort scores include a sleep quality score, wherein the sleep quality score provides a measure of guest activity during a predefined time period at night. The predefined time period at night may be any desired period of time. In some cases, for example, the predefined time period at night may include 2:00 AM-3:00 AM.

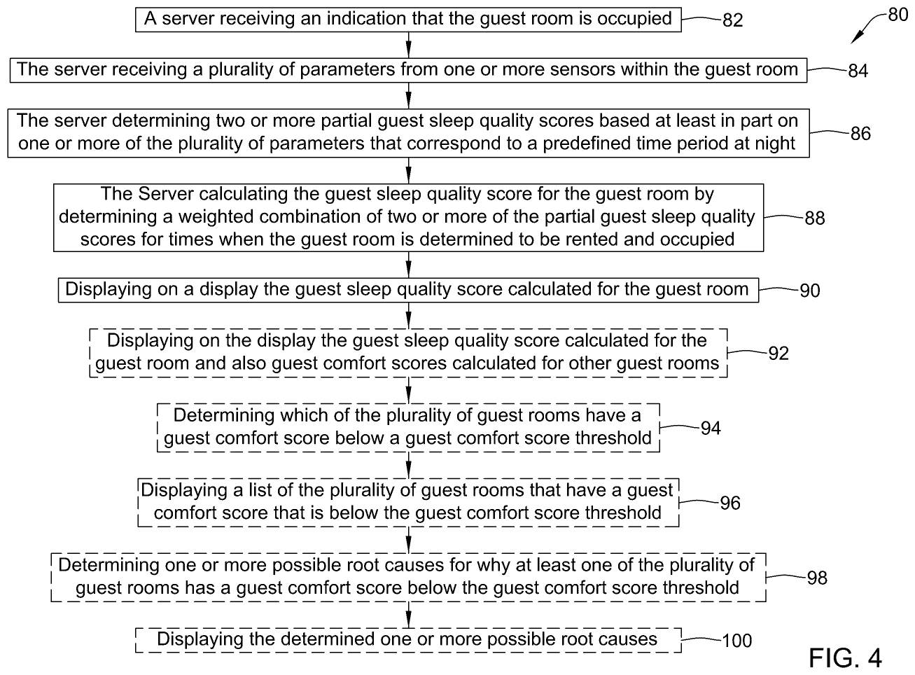

FIG. 4 is a flow diagram showing an illustrative method 80 of determining a guest sleep quality score for a guest room (such as the guest room 16) of a plurality of guest rooms of a hotel facility (such as the hotel 12), where each of the plurality of guest rooms include a connected thermostat. A server receives an indication that the guest room is occupied, as indicated at block 82. The server receives a plurality of parameters from one or more sensors within the guest room, as indicated at block 84. The server determines two or more partial guest sleep quality scores based at least in part on one of more of the plurality of parameters that correspond to a predefined time period at night, as indicated at block 86. The server calculates the guest sleep quality score for the guest room by determining a weighted combination of two or more of the partial guest sleep quality scores for times when the guest room is determined to be rented and occupied, as indicated at block 88. The server displays on a display the guest sleep quality score that was calculated for the guest room, as indicated at block 90. The guest sleep quality score may provide an indication of how well a guest within the guest room slept.

In some cases, the method 80 may further include displaying on the display the guest sleep quality score calculated for the guest room and also guest comfort scores calculated for other guest rooms, as optionally indicated at block 92. The other guest rooms may include others of the plurality of guest rooms of the hotel facility, for example. The method 80 may further include determining which of the plurality of guest rooms have a guest comfort score below a guest comfort score threshold, as indicated at block 94, as well as displaying a list of the plurality of guest rooms that have a guest comfort score that is below the guest comfort score threshold, as indicated at block 96. In some cases, the method 80 may further include determining one or more possible root causes for why at least one of the plurality of guest rooms has a guest comfort score below the guest comfort score threshold, as indicated at block 98, and displaying the determined one or more possible root causes, as indicated at block 100.

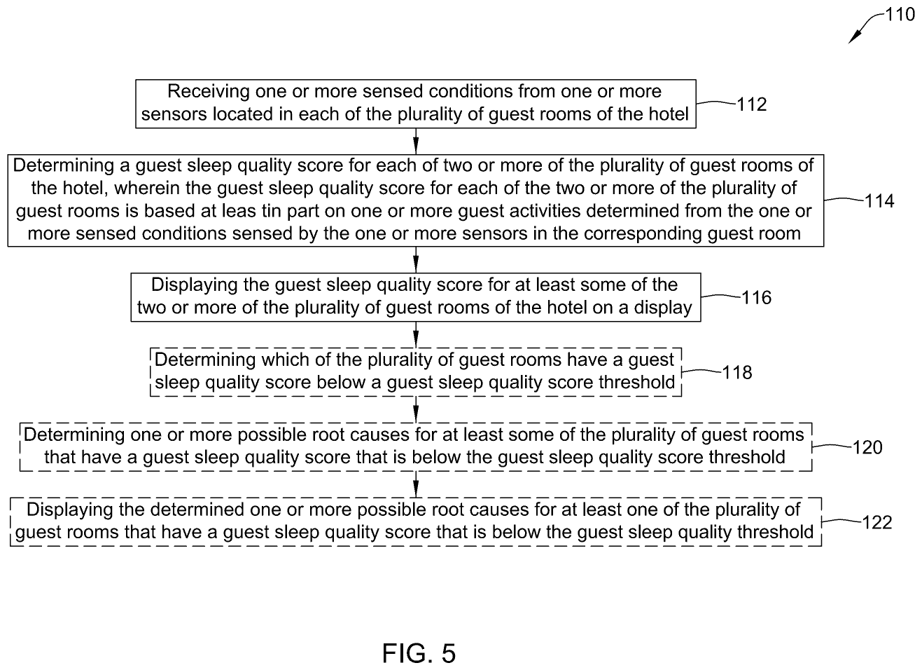

FIG. 5 is a flow diagram showing an illustrative method 110 for evaluating guest sleep quality scores for a plurality of guest rooms (such as the guest room 16) within a hotel (such as the hotel 12). One or more sensed conditions are received from one or more sensors located in each of the plurality of guest rooms of the hotel, as indicated at block 112. A guest sleep quality score is determined for each of two or more of the plurality of guest rooms of the hotel, wherein the guest sleep quality score for each of the two or more of the plurality of guest rooms is based at least in part on one or more guest activities determined from the one or more sensed conditions sensed by the one or more sensors in the corresponding guest room, as indicated at block 114.

The guest sleep quality score for each of a plurality of guest rooms of the hotel may be based at least in part one or more guest room status parameters, wherein the one or more guest room status parameters include one or more of a guest room rented parameter and a guest room occupied parameter. In some cases, each of the plurality of guest rooms includes a corresponding HVAC system (like the HVAC systems 20), and the one or more guest room status parameters may include one or more of an alarm status of the corresponding HVAC system, a cooling valve status of the corresponding HVAC system and a heating valve status of the corresponding HVAC system.

The one or more determined guest activities may include a measure related to a number of interactions with a thermostat in the corresponding guest room that occur during a defined thermostat interaction detection time period at night. The one or more determined guest activities may include a measure related to motion detected by a motion sensor in the corresponding guest room that occur during a defined motion detection time period at night. The one or more determined guest activities may include a measure related to changes in an ambient light level detected by a light sensor in the corresponding guest room that occur during a defined ambient light level detection time period at night. The one or more determined guest activities may include a measure related to a noise detected by a noise detector in the corresponding guest room that occur during a defined noise detection time period at night. In some cases, the thermostat interaction detection time period, the motion detection time period, the ambient light level detection time period and the noise detection time period may each include the period from 2 AM to 3 AM. The guest sleep quality score is displayed for at least some of the two or more of the plurality of guest rooms of the hotel on a display, as indicated at block 116.

In some instances, as optionally indicated at block 120, the method 110 may further include determining which of the plurality of guest rooms have a guest sleep quality score that is below a guest sleep quality threshold. The method 110 may further include determining one or more possible root causes for at least some of the plurality of guest rooms that have a guest sleep quality score that is below the guest sleep quality threshold, as optionally indicated at block 122. The method 110 may further include displaying the determined one or more possible root causes for at least one of the plurality of guest rooms that have a guest sleep quality score that is below the guest sleep quality threshold, as optionally indicated at block 122.

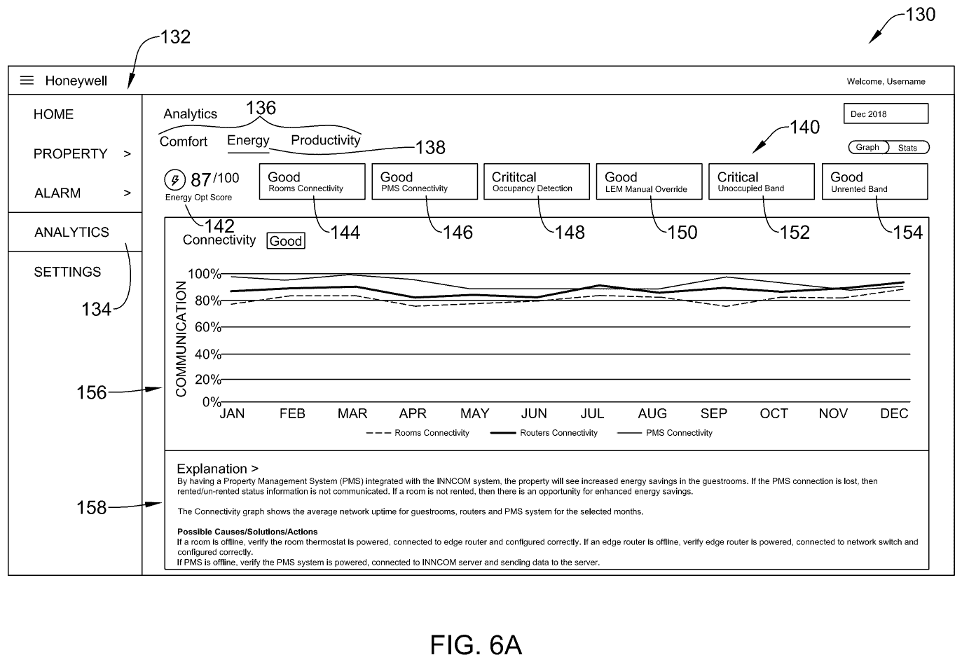

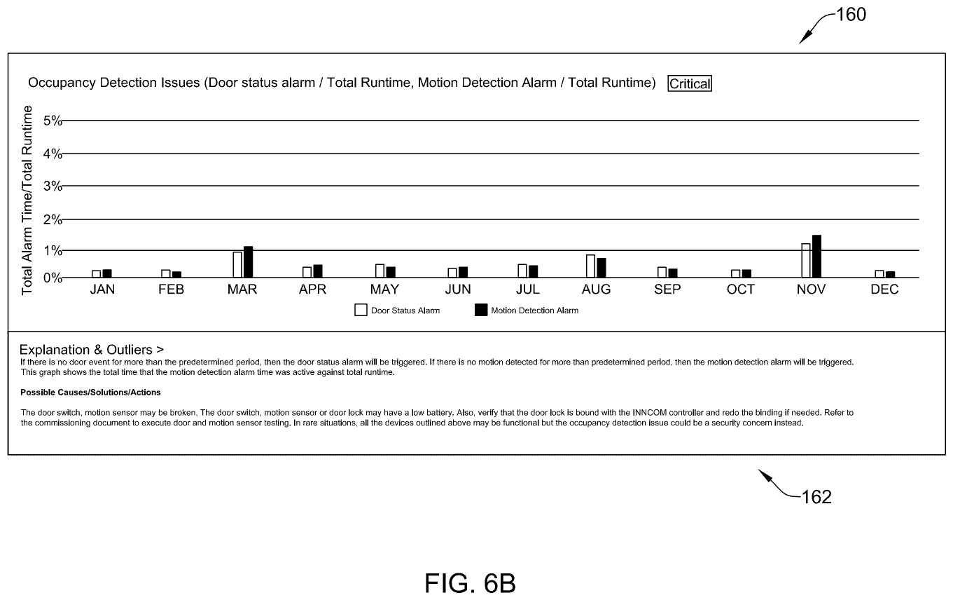

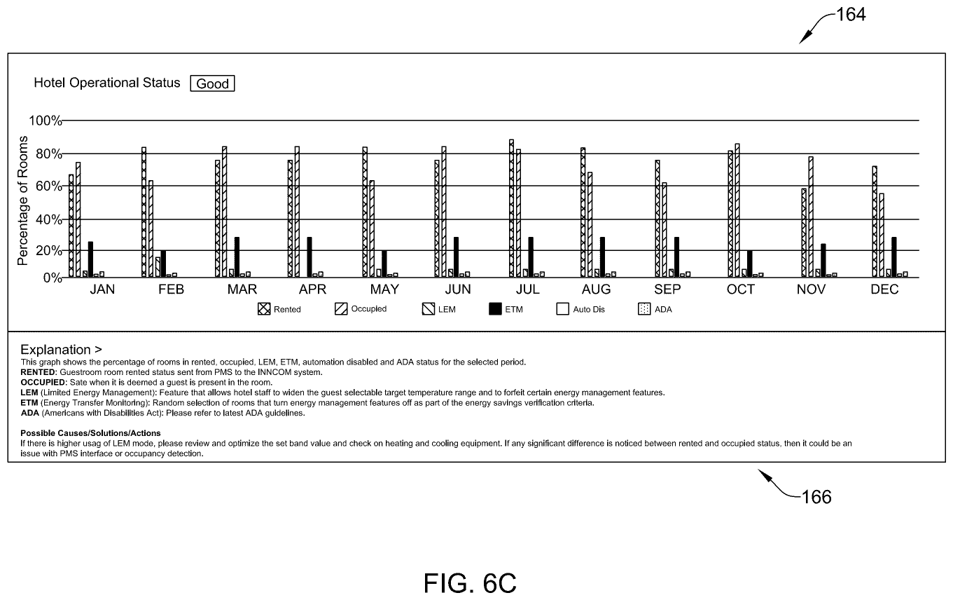

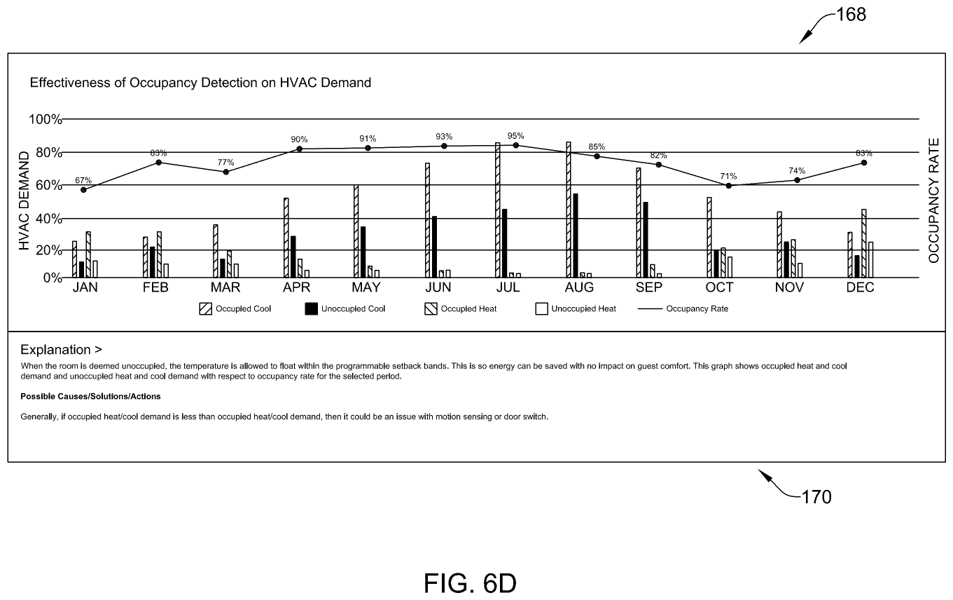

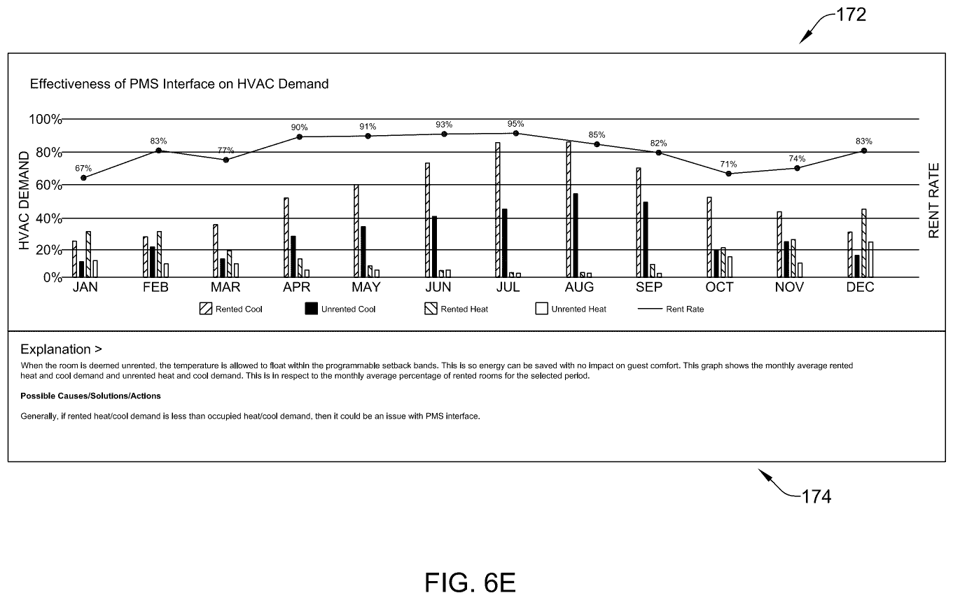

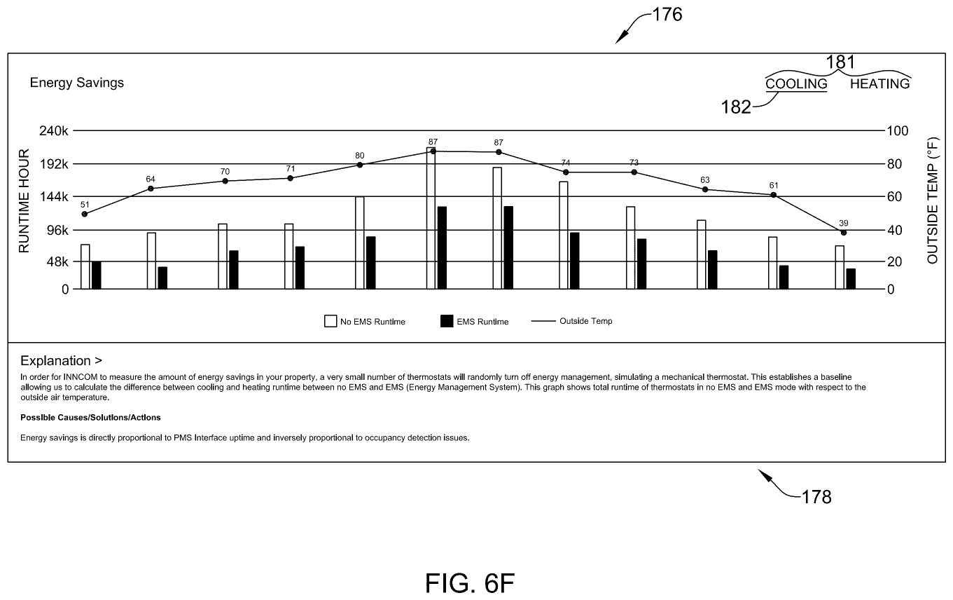

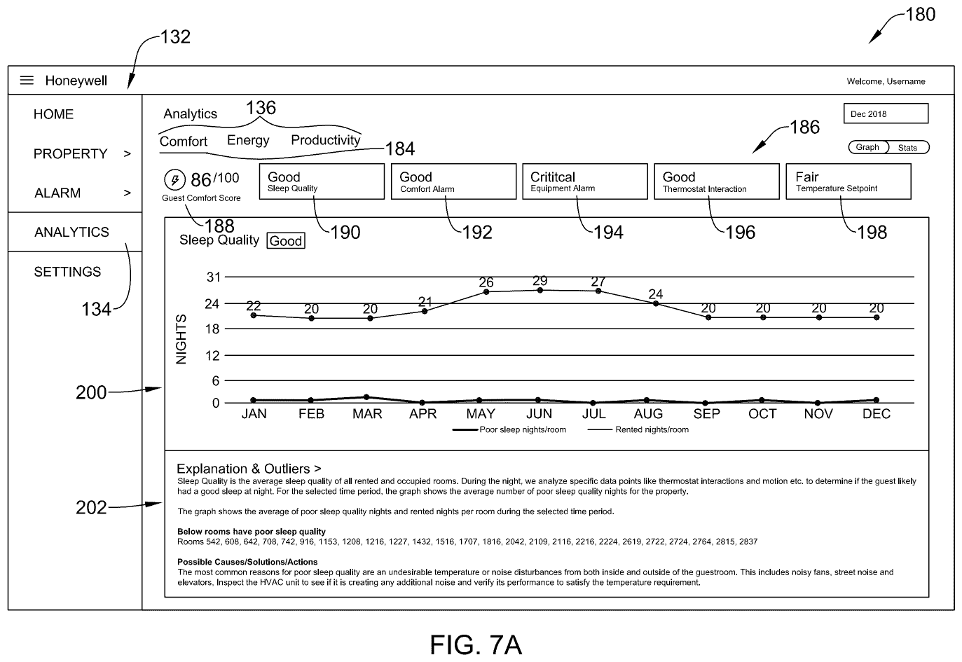

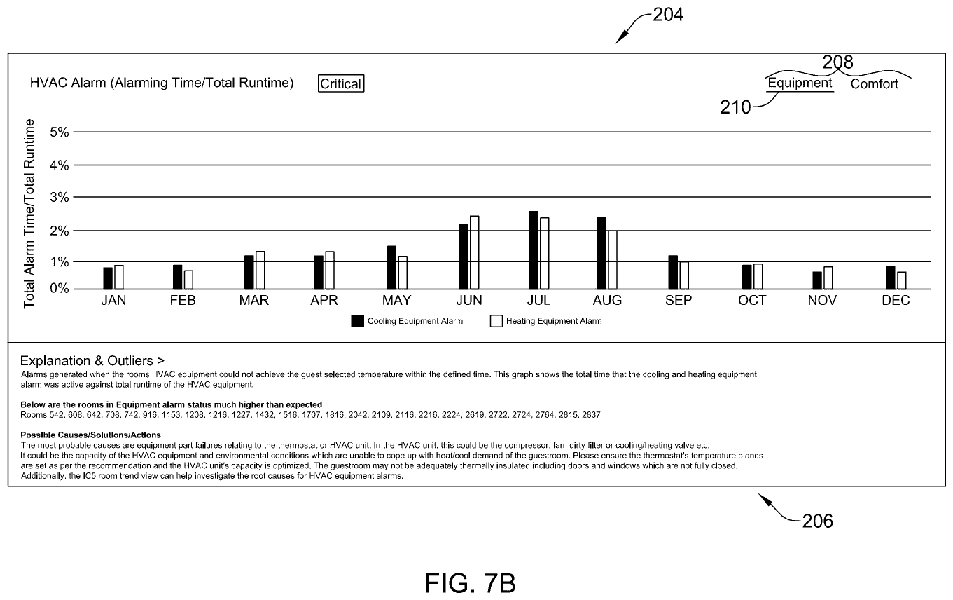

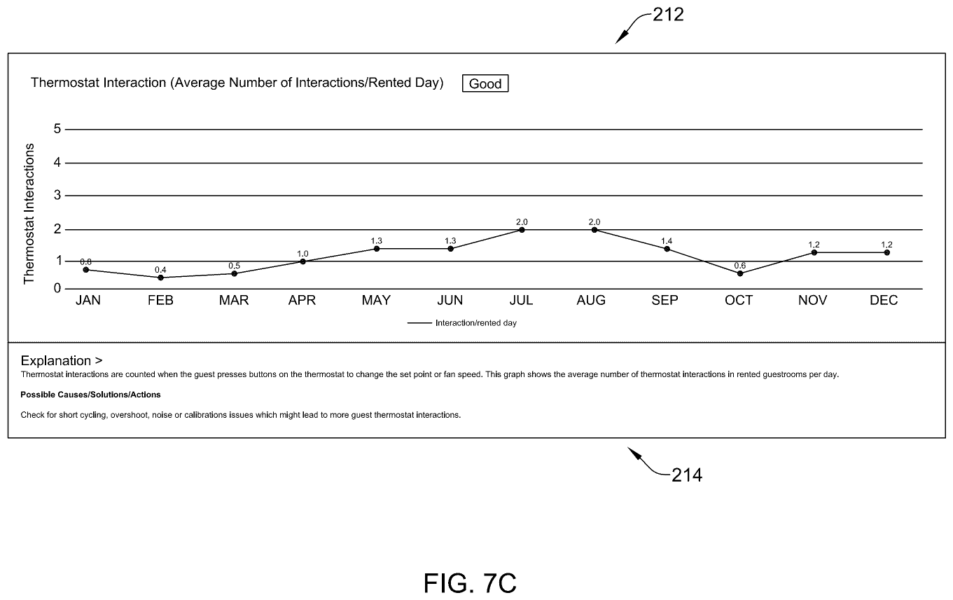

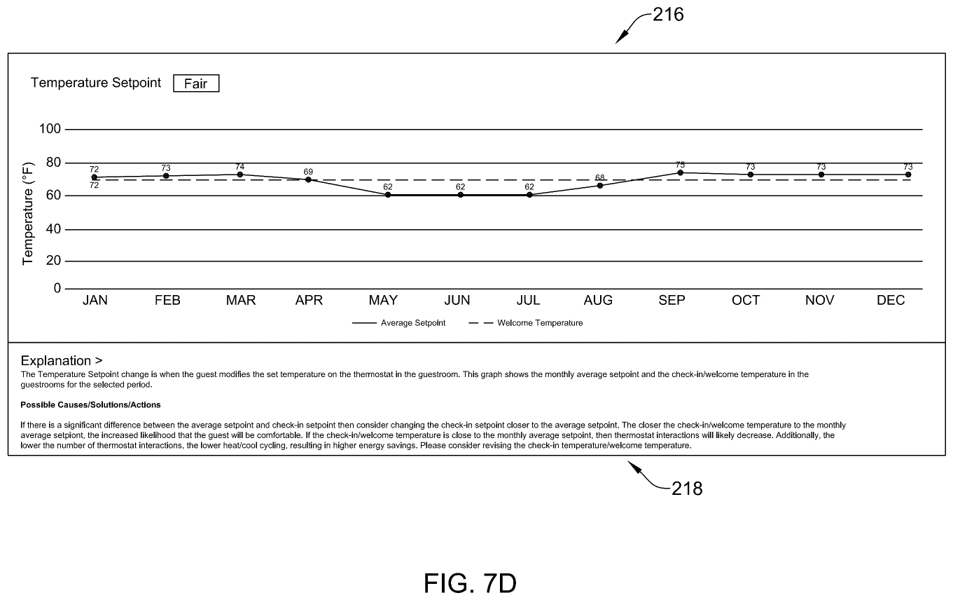

In some cases, the remote server 14 and/or the computing device 32 may be configured to display a dashboard that allows a user to quickly and easily see how a particular guest room 16 may be performing relative to other guest rooms 16 within the hotel 12, or even in comparison with the performance of similar guest rooms in other hotels. FIGS. 6A through 6F provide an example of a dashboard that may be displayed pertaining to energy, including graphical representations of many of the parameters used in calculating an energy score. FIGS. 7A through 7D provide an example of a dashboard that may be displayed pertaining to guest comfort.

In some instances, the energy score may be considered as being indicative of how well potential opportunities to conserve energy were actually taken advantage of. Detecting when a guest room 16 is empty (either not rented or rented but not currently occupied) and allowing the temperature set point to drift farther is an example of taking advantage of an opportunity to conserve energy while not negatively impacting a guest. Allowing an empty room (either not rented or rented but not currently occupied) to maintain at a comfort temperature set point is an example of failing to take advantage of an opportunity to conserve energy.

FIG. 6A is a screen shot showing a dashboard 130 that may be generated by the remote server 14 and displayed on the display 34 of the computing device 32. In some cases, the dashboard 130 may be generated directly by the computing device 32. The dashboard 130 includes a menu 132 that allows a user to choose what features they wish to view. As shown, the user has selected Analytics, as indicated by a highlighted icon 134. Across the top of the dashboard 130 is a sub-menu 136 that allows a user to choose which analytics information they wish to view. As shown, the user has selected Energy, as indicated by a highlighted icon 138. The dashboard 130 includes a summary row 140 that includes an Energy Score 142, a Rooms Connectivity icon 144, a PMS connectivity icon 146, an Occupancy Detection icon 148, a LEM Manual Override icon 150, an Unoccupied Band icon 152 and an Unrented Band icon 154. Each of the icons includes a rating such as Good, Bad, Fair, Critical such that a user can quickly see what areas may need attention.

The dashboard 130 as shown in FIG. 6A includes a graph 156 that shows connectivity data. It will be appreciated that the graphs shown in FIGS. 6B through 6F are part of the dashboard. A user may scroll up and down through the dashboard 130 to view any of these graphs. They are just separated out for drawing purposes. There is an explanation section 158 that corresponds to the connectivity graph 156, including why the connectivity data is important, and what it means. In some cases, the explanation section 158 also provides suggestions as to how to fix particular problems.

FIG. 6B shows a graph 160 pertaining to occupancy detection issues, such as but not limited to door status alarm data relative to total runtime data and motion detection alarms relative to total runtime data. The graph 160 includes an explanation section 162 that explains what is being illustrated, as well as providing possible suggestions as to how to fix particular problems. For example, FIG. 6B states “If there is not door event for more than a predetermined period, then the door status alarm will be triggered”. In this cases, the predetermined time period may be, for example, one week or one month. FIG. 6B also states “If there is no motion detected for more than a predetermined period, then the motion detection alarm will be triggered”. Again, the predetermined time period may be, for example, one week or one month.

FIG. 6C shows a graph 164 pertaining to hotel operational status. The graph 164 includes data pertaining to percentage of time rooms were rented, percentage of time rooms were occupied. FIG. 6C also shows percentage of time LEM (Limited Energy Management), ETM (Energy Transfer Monitoring), Auto Dis (Automatic Disable) and ADA (American Disabilities Act) accommodations were used. The graph 164 also includes an explanation section 166 that explains what is being illustrated, as well as providing possible suggestions as to how to fix particular problems.

FIG. 6D shows a graph 168 pertaining to effectiveness of occupancy detection on HVAC demand. The graph 168 includes information pertaining to percentages of occupied cool, unoccupied cool, occupied heat, unoccupied heat and occupancy rate. The graph 168 also includes an explanation section 170 that explains what is being illustrated, as well as providing possible suggestions as to how to fix particular problems.

FIG. 6E shows a graph 172 pertaining to effectiveness of PMS interface on HVAC demand. The graph 172 includes information pertaining to percentages of rented cool, unrented cool, rented heat, unrented heat and rental rate. The graph 172 also includes an explanation section 174 that explains what is being illustrated, as well as providing possible suggestions as to how to fix particular problems.

FIG. 6F shows a graph 176 pertaining to energy savings. The graph 176 includes information pertaining to EMS runtime, non-EMS runtime and outside temperature. The graph 176 includes a menu 181 that allows a user to select between heating and cooling. As indicated by a highlighted COOLING icon 182, the graph 176 is currently displaying energy savings pertaining to cooling. The graph 176 also includes an explanation section 178 that explains what is being illustrated, as well as providing possible suggestions as to how to fix particular problems.

FIG. 7A is a screen shot showing a dashboard 180 that may be generated by the remote server 14 and displayed on the display 34 of the computing device 32. In some cases, the dashboard 130 may be generated directly by the computing device 32. The menu 132 allows a user to choose what features they wish to view. As shown, the user has selected Analytics, as indicated by the highlighted icon 134. The sub-menu 136 allows a user to choose which analytics information they wish to view. As shown, the user has selected Comfort, as indicated by a highlighted icon 184. The dashboard 180 includes a summary row 186 that includes a Comfort Score 188, a Sleep Quality icon 190, a Comfort Alarm icon 192, an Equipment Alarm icon 194, a Thermostat Interaction icon 196 and a Temperature Setpoint icon 198. Each of the icons includes a rating such as Good, Bad, Fair, Critical such that a user can quickly see what areas may need attention.

The dashboard 180 as shown in FIG. 7A includes a graph 200 that shows sleep quality data. The graph 200 includes information pertaining to number of poor nights of sleep have been reported relative to how many nights each room has been rented. It will be appreciated that the graphs shown in FIGS. 7B through 7D are part of the dashboard 180. A user may scroll up and down through the dashboard 180 to view any of these graphs. They are just separated out for drawing purposes. There is an explanation section 202 that corresponds to the sleep quality graph 200, including why the connectivity data is important, and what it means. In some cases, the explanation section 202 also provides suggestions as to how to fix particular problems.

FIG. 7B shows a graph 204 pertaining to HVAC alarms. The graph 204 includes information pertaining to cooling equipment alarms and heating equipment alarms. The graph 204 includes a menu 208 that allows a user to select between displaying equipment alarms and comfort alarms. As indicated by a highlighted EQUIPMENT icon 210, the graph 204 is currently displaying equipment alarms. The graph 204 also includes an explanation section 206 that explains what is being illustrated, as well as providing possible suggestions as to how to fix particular problems. In the example show, the explanation section 206 also identifies those rooms in the hotel 12 that were in equipment alarm status much higher than expected.

FIG. 7C shows a graph 212 pertaining to thermostat interactions. The graph 212 includes information pertaining to how many times per day a guest interacted with the thermostat in their particular guest room. If a guest interacts frequently with the thermostat, this can indicate that the guest is not comfortable. This can mean that there are HVAC equipment issues, for example. On the other hand, this could also indicate a family renting the room, where individual members of the family do not agree with respect to a desired temperature set point. The graph 212 also includes an explanation section 214 that explains what is being illustrated, as well as providing possible suggestions as to how to fix particular problems.

FIG. 7D shows a graph 216 pertaining to thermostat set points. The graph 216 includes information pertaining to actual (guest) temperature set points relative to a welcome temperature set point set by the hotel. This may alert the hotel staff to change the welcome temperature set point with the seasons to match their guest preferences. The graph 216 also includes an explanation section 218 that explains what is being illustrated, as well as providing possible suggestions as to how to fix particular problems.

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method of determining a guest comfort score for a guest staying in a guest room of a plurality of guest rooms of a hotel facility, the method comprising:
a server determining that the guest room is rented and occupied;
the server determining a measure of guest activity in the guest room during a predefined time period at night when the guest room is determined to be rented and occupied;
the server determining a sleep quality score for the guest room, wherein the sleep quality score is based at least in part on the measure of guest activity detected in the guest room during the predefined time period at night when the guest room is determined to be rented and occupied; and
the server sending for display on a display the sleep quality score determined for the guest room.

2. The method of claim 1, comprising:
the server receiving a plurality of parameters from one or more devices within the guest room, wherein the measure of guest activity in the guest room is determined based at least in part on one or more of the plurality of parameters.

3. The method of claim 1, comprising:
the server receiving a plurality of parameters from one or more devices within the guest room, wherein one of more of the plurality of parameters from one or more devices within the guest room relate to conditions in the guest room, and wherein the sleep quality score is based at least in part on one of more of the plurality of parameters that relate to conditions in the guest room during the predefined time period at night when the guest room is determined to be rented and occupied.

4. The method of claim 3, wherein the plurality of parameters comprises one or more of:
a parameter that provides a measure of guest interactions with a thermostat of the guest room during the predefined time period at night;
a parameter that provides a measure of motion in the guest room during the predefined time period at night;
a parameter that provides a measure of changes in ambient light in the guest room during the predefined time period at night; and
a parameter that provides a measure of noise in the guest room during the predefined time period at night.

5. The method of claim 1, wherein the measure of guest activity in the guest room is based at least in part on a measure of how often the guest interacted with a thermostat of the guest room during the predefined time period at night.

6. The method of claim 1, wherein the measure of guest activity in the guest room is based at least in part on a measure of motion in the guest room during the predefined time period at night.

7. The method of claim 1, wherein the measure of guest activity in the guest room is based at least in part on a measure of changes in ambient light in the guest room during the predefined time period at night.

8. The method of claim 1, wherein the measure of guest activity in the guest room is based at least in part on:
a measure of how often the guest interacted with a thermostat of the guest room during the predefined time period at night;
a measure of motion in the guest room during the predefined time period at night; and
a measure of changes in ambient light in the guest room during the predefined time period at night.

9. The method of claim 1, the sleep quality score provides an estimate of how well the guest slept in the guest room.

10. The method of claim 1, further comprising:
the server receiving a plurality of parameters from one or more devices within the guest room, wherein one of more of the plurality of parameters from one or more devices within the guest room relate to conditions in the guest room;
the server determining two or more partial sleep quality scores based at least in part on two or more of the plurality of parameters from two or more devices within the guest room; and
the server determining the sleep quality score based at least in part on the two or more partial sleep quality scores.

11. The method of claim 1, further comprising:
the server sending for concurrent display on a display the sleep quality score for the guest room and a sleep quality score for at least one other guest room of the hotel facility.

12. The method of claim 11, further comprising:
the server determining when the sleep quality score is below a sleep quality score threshold; and
the server visually distinguishing the guest room on the display when the sleep quality score of the guest room is below the sleep quality score threshold.

13. The method of claim 12, further comprising:
the server determining one or more possible root causes for why the sleep quality score of the guest room is below the sleep quality score threshold; and
the server sending for display one or more of the possible root causes.

14. A system for determining a sleep quality score for a guest room of a hotel having a plurality of guest rooms, the system comprising:
a hotel network to which each of the plurality of guest rooms are operably coupled;
a server operatively coupled to the hotel network, the server configured to:
determine when the guest room is rented and occupied;
receive via one or more networks including the hotel network a plurality of parameters from one or more devices within the guest room;
determine a measure of guest activity in the guest room during a predefined time period at night when the guest room is determined to be rented and occupied based at least in part on one of more of the plurality of parameters that are received from the one or more devices within the guest room;
determine a sleep quality score for the guest room, wherein the sleep quality score is based at least in part on the measure of guest activity in the guest room during the predefined time period at night when the guest room is determined to be rented and occupied; and
send the sleep quality score of the guest room to a display device for display.

15. The system of claim 14, wherein one of more of the plurality of parameters from one or more devices within the guest room relate to conditions in the guest room, and wherein the server is configured to determine the sleep quality score based at least in part on one of more of the plurality of parameters that relate to conditions in the guest room during the predefined time period at night when the guest room is determined to be rented and occupied, including one or more of:
a parameter that provides a measure of a number of guest interactions with a thermostat of the guest room during the predefined time period at night;
a parameter that provides a measure of motion of a guest in the guest room during the predefined time period at night;
a parameter that provides a measure of changes in ambient light in the guest room during the predefined time period at night; and
a parameter that provides a measure of noise in the guest room during the predefined time period at night.

16. The system of claim 14, wherein:
the server determines when the sleep quality score is below a sleep quality score threshold; and
the server visually distinguishes the guest room on the display device when the sleep quality score of the guest room is below the sleep quality score threshold.

17. The system of claim 14, wherein:
the server determines when the sleep quality score is below a sleep quality score threshold;
the server determines one or more possible root causes for why the sleep quality score of the guest room is below the sleep quality score threshold; and
the server sends for display on the display device one or more of the possible root causes.

18. A non-transient computer readable medium storing one or more instructions that when executed by one or more processors cause the one or more processors to:
determine that a guest room of a hotel facility is rented and occupied;
determine a measure of guest activity in the guest room during a predefined time period at night when the guest room is determined to be rented and occupied;
determine a sleep quality score for the guest room, wherein the sleep quality score is based at least in part on the measure of guest activity detected in the guest room during the predefined time period at night when the guest room is determined to be rented and occupied; and
send for display on a display device the sleep quality score determined for the guest room.

19. The non-transient computer readable medium of claim 18, wherein the one or more instructions cause the one or more processors to receive a plurality of parameters from one or more devices within the guest room, wherein one of more of the plurality of parameters from one or more devices within the guest room relate to conditions in the guest room, and wherein the sleep quality score is based at least in part on one of more of the plurality of parameters that relate to conditions in the guest room during the predefined time period at night when the guest room is determined to be rented and occupied.

20. The non-transient computer readable medium of claim 19, wherein the plurality of parameters comprises one or more of:
a parameter that provides a measure of guest interactions with a thermostat of the guest room during the predefined time period at night;
a parameter that provides a measure of motion in the guest room during the predefined time period at night;
a parameter that provides a measure of changes in ambient light in the guest room during the predefined time period at night; and
a parameter that provides a measure of noise in the guest room during the predefined time period at night.
